(19) United States
(12) Patent Application Publication
(10) Pub. No.: US 2025/0157075 A1
(43) Pub. Date: May 15, 2025

(54) Camera-Based System And Method For Determining The Position Of A Trailer

(71) Applicant: MEKRA Lang GmbH & Co. KG, Ergersheim (DE)

(72) Inventors: Thomas RICHTER, Eckental (DE); Kai FAUTH, Margetshoechheim (DE); André KOEHLER, Nuernberg (DE); Christian KERSTEN, Fuerth (DE); Christian BAUER, Gutenstetten (DE); Anne SCHADE, Wuerzburg (DE)

(73) Assignee: MEKRA Lang GmbH & Co. KG, Ergersheim (DE)

(21) Appl. No.: 18/924,348

(22) Filed: Oct. 23, 2024

(30) Foreign Application Priority Data
Nov. 10, 2023 (DE) 102023131347.9

(51) Int. Cl. G06T 7/73; B60R 1/26; G06V 10/44; G06V 20/56

(52) U.S. Cl. CPC G06T 7/73; B60R 1/26; G06V 10/44; G06V 20/56; B60R 2300/8086; G06T 2207/30252

(57) ABSTRACT

Determining the position of a trailer end of a trailer (5) extending from a towing unit (4) of a vehicle and being pivotable thereto, by processing camera images (6) captured successively in time by an image sensor of an image capturing device (2) of a camera-based system; and determining a plurality of feature points (8) in the images (6) based on a parameter. The feature point (8) corresponds to a pixel in the image (6). Selecting relevant feature points from the plurality (8) along a preferred direction defined by density and position of the points (8) as path elements (10) based on a positional displacement (dx, dy) between the points (8) in an image (6) and corresponding points (8) in another image (6); generating a path (11) describing the trailer (5) along the preferred direction; and determining a position on the path (11) at the trailer end.

### BACKGROUND OF THE INVENTION

### 1. Field of the Invention

The invention relates to a camera-based system (viewing system or mirror replacement system) and a method for determining the position of an end (edge) of a trailer rearwardly extending from a vehicle and which is pivotable to the vehicle, suitable for commercial vehicles having a semi-trailer, a trailer, or another unit pivotable with respect to a driver's cab or the tractor unit and rearwardly extending.

The driver of a vehicle comprising a tractor unit or towing unit having a trailer that extends to the rear, and which is pivotable to the unit, usually observes traffic behind by means of a side mirror attached to the side of the towing unit. Such side mirrors are increasingly being replaced by camera systems, such as camera monitor systems, respectively mirror replacement systems mounted at a side or at a rear part of the vehicle. They replace or supplement conventional mirror systems which are prescribed for a motor vehicle, such as for example exterior mirrors (main mirrors), interior mirrors on cars or wide-angle mirrors and front mirrors on commercial vehicles.

In the systems mentioned above, for example, a corresponding field of view, which is conventionally visible by a mirror, is permanently and in real time shown to the driver of the vehicle on a monitor or other display unit, for example in the interior of the vehicle, so that the driver of the vehicle always has a view of the corresponding field of view, although he neither has a direct view of the corresponding field of view nor is a mirror provided.

A trailer in the sense of the present teaching comprises trailers which are coupled to a vehicle (tractor or towing unit) by means of a trailer coupling, for example a semi-trailer (so-called trailers), and which are placed at the rear, lowered area of a tractor unit and pivotably connected about at least one vertical axis. Alternatively, such trailers can also be trailers attached to passenger cars, wherein in this case, the passenger car corresponds to the tractor unit. In general, a trailer is a rearwardly extending part which is located rearward with respect to a driver's cab of a vehicle, and a part which is movable (pivotable) to a side with respect to the driver's cab, and which pivots about a vertical axis relative to the driver's cab when cornering. Articulated trucks or articulated trains are also trailers within the meaning of the invention.

However, when using a mirror replacement system as described above, the rearward traffic is increasingly concealed in an image of a mirror replacement system for the field of view class II according to ECE R46 with increasing buckling angle (kink angle or bending angle) between a towing unit and a trailer when a vehicle with the towing unit and the trailer is cornering. Further, the rear part of the trailer is lost (disappears) near the rear axle, which can cause the end of the trailer to disappear from a monitor image displayed to the driver.

To solve this problem, there are already methods for tracking the end edge of the trailer and for shifting the image section displayed on a monitor such that the trailer end edge is displayed in the center of the monitor image, as far as this is possible. According to EP 16 198 485, this tracking of the trailer end edge is currently carried out, for example, by means of vehicle sensors, which acquire information about a rotary movement of the wheels. This information is analyzed by a control unit to determine the rear area of the rearwardly extending part and to appropriately track it based on the acquired information about the rotary movement of the wheels. However, as these sensors can only provide reliable signals above a certain speed, e.g. from approximately 2 km/h, such tracking of the trailer end edge can only be provided when driving forward at higher speeds. These sensors cannot be used for maneuvering backward and at low speeds for detecting a trailer end edge with sufficient accuracy for tracking (updating) the trailer end edge in a monitor image.

### SUMMARY OF THE INVENTION

An object of the invention is to solve the above-mentioned problem and to detect the position of the trailer end with sufficient accuracy during backward maneuvering operations and at low speeds for tracking (updating) in a monitor image, irrespective and independent of trailer type and information acquired by installed sensors, for example.

A method is disclosed for determining the position of a trailer end or a trailer end edge of a trailer extending rearwards from a towing unit of a vehicle, processes camera images successively captured in time by an image sensor of a camera-based system. The camera images used for processing do not have to be captured in direct succession, for example, only every second or third camera image can be used for further processing, which can reduce the amount of image data to be processed. Before the captured camera images are processed, they can, for example, be suitably processed with respect to their resolution, contrast and/or color information. Raw data of the captured camera images may be used or camera images which are partly processed may be used in the method according to the present invention.

When further processing the successive camera images, the method according to the invention determines in each camera image so-called feature points based on one or more image parameters, at least a calculated quantity of one or more image parameters and/or their gradients, wherein a feature point corresponds to at least one pixel within the camera image. A pixel in the camera image can be determined as feature point if, for example, a value of an image parameter of this pixel differs from a value of a corresponding image parameter of one or of more neighbor pixels by a preset value.

For example, several neighboring pixels that form a pixel cluster may also be compared with an adjacent or neighboring pixel cluster regarding at least one image parameter for determining a feature point. The pixels or pixel clusters do not have to be directly next to each other, a spatial proximity to each other may be sufficient.

The method according to the invention then selects a plurality of path elements from the determined feature points based on a position displacement (positional shift) between the plurality of feature points in a camera image and a corresponding plurality of feature points in a camera image subsequent in time. The determination of the path elements is carried out, for example, along a predetermined direction that extends along the trailer in the direction of the trailer end and can preferably be determined by the density and/or position of the feature points. The predetermined direction can be fixed or preferably dynamically adjusted during the process. A dynamic adjustment can be based on already defined path elements. Based on these path elements, the method according to the invention then generates at least one so-called path (pathway) that describes the trailer course and determines a position (location) on this at least one path as the position (location) of the trailer end edge. The determined path elements or feature points have relevant x-, y-, dx-, dy-coordinates, wherein the dx- and dy-coordinates indicate a positional shift or positional movement in x- and y-direction.

According to an advantageous embodiment of the method according to the invention, the feature points are weighted before the path elements are selected. Such a weighting can, for example, be based on a difference in contrast between pixels or pixel clusters and neighboring pixels or pixel clusters or pixels or pixel clusters in close proximity. One or more known image parameters can serve as a basis for the weighting. Further, the positional shift (dx, dy) between a feature point in a camera image and the corresponding feature point in a subsequent camera image can also be used as an alternative or additional weighting basis.

According to a further advantageous embodiment of the method according to the invention, the above selection of path elements, weighting of feature points and/or weighting of the path elements may be based on a buckling angle (kink angle) and/or information about the relative positional relationship between the towing unit and the trailer and/or on a vehicle speed. Such a buckling angle or relative positional relationship may be determined independent from the acquired camera images, for example by means of a buckling angle sensor mounted on the vehicle or may be estimated by data received form a steering angle sensor. Alternatively, it may be estimated by image analysis. Other signals of the driving status acquired by sensors installed in the vehicle can also be considered additionally or alternatively.

According to a further advantageous embodiment of the method according to the invention, the at least one path is a mathematical function defined by the path elements and/or weighted path elements, preferably a nth order polynomial, for example a straight line from which the path elements are substantially equally spaced on average.

According to an advantageous embodiment of the method, the image parameter is for example at least one of brightness value, color value, grey tone or gradient of these values, wherein prior to determining the feature points in a camera image, this camera image remains unprocessed or is suitably processed to make a difference in contrast, difference in brightness, etc. even more clearly visible. Other images parameters not explicitly listed here are also conceivable.

According to a further advantageous embodiment of the method according to the invention, the last found path element can be used as an initialization point and further feature points can be selected along the path that are within a predetermined distance from the path. A projection of the last found feature point determined in this way onto the path can then indicate the position of the trailer end edge. In this way, the actual position of the trailer end can be further approximated. The information about the actual determined position of the trailer end can be output for example by a CAN- and/or Ethernet system and/or can be exchanged between software modules.

According to a further advantageous embodiment of the method according to the invention, the position of the trailer end edge found in this way can be tracked (updated) in camera images successive in time such that the end of the trailer always appears substantially in the center of each of the camera images that follow one another in time. This means that even with a given buckling angle, that a trailer assumes in relation to the tractor unit, traffic to the rear can be perceived more reliably by the driver of the vehicle.

According to a further advantageous embodiment of the method according to the invention, further vehicle features may be considered and used for correcting the determined position of the trailer end edge. Such vehicle features can, for example, include geometric characteristics such as length, width, height, etc. and can be permanently stored in advance for a specific type of trailer. Other vehicle characteristics, such as the position of rear position lamp can be used for the correction. This information can be obtained from another process, for example via a CAN- or Ethernet system or can be provided by other software modules.

According to a further advantageous embodiment of the method according to the invention, the determined position of the trailer end edge is verified by generating a block grid having a plurality of rows and columns defining cells on at least a part of the camera image. The block grid is preferably created on the image where the position of the trailer end edge has been determined. By the creation of the block grid, the determined feature points are distributed over the plurality of cells of the block grid. This means, that each cell comprises several feature points. According to the invention, the distribution of the feature points within the created block grid is compared with distributions of feature points of a plurality of correspondingly stored block grids. The stored block grids define different distributions of feature points together with an actual trailer end. From the stored block grids the block grid that correlates best with the created block grid is selected to verify the determined position of the trailer end edge, and by comparing the determined position of the trailer end with the actual position of the trailer end defined in the selected block grid, a plausibility check can be carried out. If necessary, the determined position of the trailer end can be corrected based on this plausibility check if it deviates too much from the actual position, or the determination of the position of the trailer end can be carried out again.

According to a further advantageous embodiment of the method according to the invention, distributions of feature points together with the corresponding position of the trailer end can be stored in a block grid in advance or can be generated and stored in real time at fixed or dynamically adjustable time intervals. The determined distribution is then compared with such predetermined distributions and the position of the trailer end is thus verified.

According to a further advantageous embodiment of the method according to the invention, the different distributions of feature points with the corresponding trailer end in the stored block grids depend on the buckling angle between trailer and towing unit. Information about the buckling angle can for example be stored together with each block grid. This means that, for example, if the current buckling angle or the relative positional relationship between trailer and towing unit is known, the stored block grid for this buckling angle can directly be found and the verification of the position of the determined trailer end can be carried out. Other information can be used that indicates the position of the trailer relative to the towing unit.

The camera-based system according to the invention comprises at least one camera having an image sensor for capturing (acquiring) camera images successive in time of a side area of the trailer, a monitor for displaying an image captured by the camera, and at least one processor configured for executing the above-described method according to the invention. According to an advantageous further development, the camera-based system according to the invention is a mirror replacement system approved according to UN ECE R46, preferably for commercial vehicles.

### Aspects of the Invention

According to one aspect, a method is described for determining the position of a trailer end in a camera image (6) of a trailer (5) extending rearward from a towing unit (4) of a vehicle and being pivotable to the towing unit (4), by processing camera images (6) captured successively in time, comprising the steps of:
capturing the camera images (6) being successive in time by at least one image sensor of at least one image capturing means (2);
determining a plurality of feature points (8) in each camera image (6) used for the method, based on at least one image parameter, wherein a feature point (8) corresponds to at least one pixel in the camera image (6);
determining at least one path element (10) by using the plurality of feature points (8) along a predetermined direction in relevant coordinates x and/or y and/or dx and/or dy based on a determined positional shift in corresponding coordinates x and/or y and/or dx and/or dy between the plurality of feature points (8) in at least one camera image (6) and a corresponding plurality of feature points (8) in at least one camera image (6) successive in time;
generating of at least one path (11) along the predetermined direction based on the path elements (10), the path (11) describing the position of the trailer (5); and
determining a position on the path (11) as the trailer end.

According to another aspect, the predetermined direction is determined by density and position of the feature points (8).

According to another aspect, the disclosed method further comprises the steps:
weighting the feature points (8); and
determining the path elements (10) from the weighted feature points (8).

According to another aspect, the disclosed method(s) further comprise the steps:
weighting the path elements (10); and
generating the at least one path (11) based on the weighted path elements (10).

According to another aspect, the disclosed method(s) further comprise the step of
acquiring information about the relative positional relationship between the trailer (5) and the towing unit (4) of the vehicle, wherein the determining of the path elements, the weighting of the feature points (8) and/or the weighting of the path elements (10) is based on the acquired information about the relative positional relationship between the trailer (5) and the towing unit (4) of the vehicle.

According to another aspect, in the disclosed method(s) the at least one path (11) is generated as a mathematical function specified by the path elements (10) or weighted path elements (10).

In accordance with another aspect, in the disclosed method(s) the at least one image parameter is at least one of brightness value, color value, grey tone, contrast value and/or a calculated quantity from one of these values and/or their gradients of a pixel and/or pixel cluster in a camera image (6).

In accordance with another aspect, the disclosed method(s) further comprise
setting, as a starting point, an initialization point (IP), that is located on the generated path (11), or that is at least one path element (10) of the at least one path (11), or that is at least a further feature point (8) that does not exceed a predetermined distance from the at least one path (11), or a calculated quantity of the path elements (10) or the further feature points (8); and
searching for at least a further feature point (8) starting from the starting point and along the path (11), that does not exceed a predetermined distance from the at least one path (11); and
setting a coordinate of the at least one further identified feature point (8) and/or a calculated quantity of the at least one feature points (8) as the position (EP) of the trailer end.

In accordance with another aspect, the disclosed method(s) further comprise the steps of
acquiring at least one vehicle feature; and
correcting the determined position of the trailer end based on the acquired at least one vehicle feature.

In accordance with another aspect, the disclosed method(s) further comprise the step of verifying the determined position of the trailer end, wherein the step of verifying comprises following steps:
generating a block grid (13) on at least a section of the camera image (6), wherein the block grid (13) defines a plurality of cells (14), and determining a distribution of the plurality of feature points (8) over the plurality of cells (14) of the block grid (13) as part of the generated block grid (13);
comparing the distribution of feature points (8) in the generated block grid (13) with distributions of feature points of a plurality of stored corresponding block grids, wherein the stored block grids each define different distributions of feature points together with an actual trailer end;
selecting one of the stored block grids based on a correlation between the distribution of feature points (8) in the generated block grid (13) and the distribution of feature points in the stored block grids;
verifying the determined position of the trailer end (12) by comparing the actual position of the trailer end defined by the selected block grid with the determined position of the trailer end (12).

In accordance with another aspect, the disclosed method(s) further comprise a correcting of the determined position of the trailer end (12) based on the verification.

In accordance with another aspect, in the disclosed method(s) the distributions of feature points and the corresponding trailer ends in the stored block grids are stored in advance or generated and stored in real time in fixed defined or dynamically adjustable time intervals.

In accordance with another aspect, in the disclosed method(s) the distribution of feature points in one of the stored block grids differs from the distributions of feature points in another of the stored block grids according to information about the relative positional relationship between trailer (5) and towing unit (4).

In accordance with another aspect the disclosed method(s) further comprise tracking the determined position of the trailer end in camera images (6) which are successive in time, depending on the position of the trailer (5) with respect to the image sensor acquiring the camera images (6) such that the trailer end appears at a preferred position in the monitor image of at least one display means (1) of a camera-based system.

In another embodiment, a camera-based system of a vehicle having a towing unit (5) and a trailer (4) rearwardly extending and being pivotable to the towing unit (5) is disclosed. The camera-based system comprises
at least one image capturing means (2) provided at the towing unit (5) and having at least one image sensor for capturing camera images (6) of an area of the trailer (5) which are successive in time; and
at least one processing means (3) configured for performing any of the disclosed method(s).

In another disclosed embodiment, the camera-based system further comprising at least one display means (1) for displaying a camera image (6) captured by the at least on image capturing means (2) and tracking the determined position of the trailer end in the camera images (6) which are successive in time depending on the position of the trailer (5) with respect to the image sensor acquiring the camera image (6) such that the trailer end appears at a preferred position in the monitor image of the display means (1).

In a further disclosed embodiment, a camera-based system is disclosed which is approved according to UN ECE R46.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, the invention is described purely by way of examples with reference to the attached figures with identical reference signs indicating identical or similar components.

FIG. 1 shows a schematic representation of a camera-based system according to a preferred embodiment of the present invention;

FIG. 2a shows a top view of a vehicle using the camera-based system of FIG. 1 in a first driving situation corresponding to a straight ahead driving;

FIG. 2b shows a top view of the vehicle using the camera-based system of FIG. 1 in a second driving situation corresponding to cornering;

FIG. 3 shows a camera image captured by the camera-based system of FIG. 1 as an image displayed on a monitor for explaining the method for determining a position of a trailer end according to a preferred embodiment of the invention;

FIG. 4 shows the camera image according to FIG. 3 for illustrating the determination of feature points according to the preferred embodiment of the invention;

FIG. 5 shows a schematic three-dimensional representation of a part of the camera image according to FIG. 3 for illustrating a positional shift of feature points between two successive camera images according to the preferred embodiment of the invention;

FIG. 6 shows a schematic three-dimensional representation according to FIG. 5 for illustrating the determination of path elements according to the preferred embodiment of the invention;

FIG. 7 shows the camera image according to FIG. 3 with superimposed path elements along a trailer lower edge according to the preferred embodiment of the invention;

FIG. 8 shows the camera image according to FIG. 3 with superimposed alternative path elements along the structure of the trailer according to the preferred embodiment;

FIG. 9 shows the camera image according to FIG. 7 with a symbolic representation of the movement of the feature points and path elements;

FIG. 10 shows a presentation for illustrating the determination of the position of the trailer end according to the preferred embodiment of the invention;

FIG. 11 shows the camera image according to FIG. 9 with the trailer end determined according to the preferred embodiment of the invention;

FIG. 12 shows the camera image according to FIG. 3 with tracked (updated) trailer end according to the preferred embodiment of the invention;

FIG. 13 shows the camera image according to FIG. 3 with a block grid according to the preferred embodiment of the invention;

FIG. 14 shows a cell of the block grid of FIG. 13 with feature points according to the preferred embodiment of the invention; and

FIG. 15 shows the camera image according to FIG. 3 with tracked (updated) trailer end according to the preferred embodiment of the invention.

### DETAILED DESCRIPTION OF THE PRESENTLY PREFERRED EMBODIMENTS

FIG. 1 shows a camera-based system according to a preferred embodiment of the invention having display means 1a, 1b, image capturing means 2a, 2b and processing means 3a, 3b.

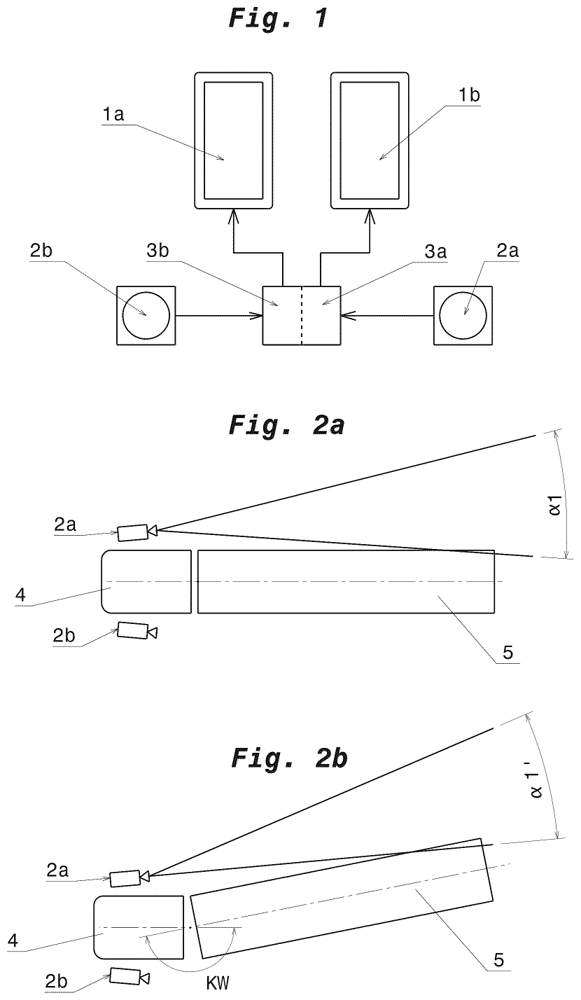

The image capturing means 2a, 2b are preferably arranged on opposite sides of a vehicle, and respectively connected to the display means 1a, 1b via the processing means 3a, 3b. The image capturing means 2a, 2b are arranged on opposite sides of the vehicle, as for example shown in FIG. 2. The processing means 3a, 3b according to the preferred embodiment comprise buckling angle determination means, and image data processing means, not described in more detail, and are in particular able to carry out the method according to the invention for determining the position of a trailer end, for tracking (updating) and correcting the trailer end on the display means 1a, 1b, as described below.

For the sake of simplicity, only the display means 1a, the image capturing means 2a and the processing means 3a are described. However, the explanations apply analogously to the display means 1b, the image capturing means 2b and the processing means 3b on the opposite side of the vehicle. Further, according to the preferred embodiment, only a single processing unit can be provided which assumes the function of the processing means 3a and 3b.

As shown in FIGS. 2a and 2b, the vehicle comprises a towing vehicle 4 and a trailer 5 pivotally attached thereto, for example. The image capturing means 2a covers with its recording area a viewing area or a field of view, which corresponds to a “main mirror (large) group II” according to ECE-R46. Other suitable defined fields of view can be covered by the image capturing means 2a in accordance with national regulations.

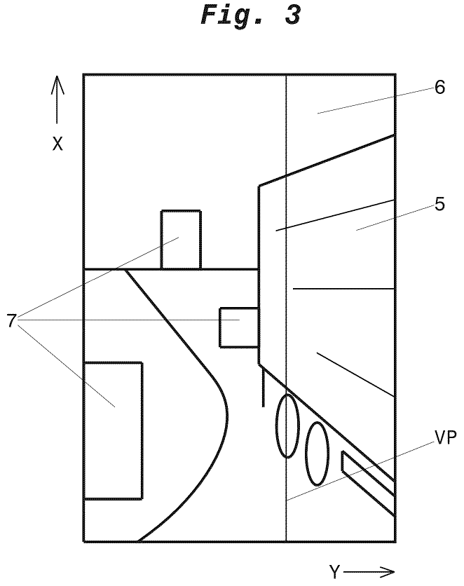

FIG. 2a shows the vehicle travelling straight ahead without a buckling angle between the towing vehicle 4 and the trailer 5. When cornering, as shown in FIG. 2b, the buckling angle between the towing vehicle 4 and the trailer 5 is generated, and with increasing buckling angle the rear end of the trailer 5 is shifted (moved) in the field of view of the image capturing means 2a. FIG. 3 shows a camera image 6 captured by the image capturing means 2a on a monitor (monitor image), wherein the end of the trailer 5 conceals the rearward traffic with increasing buckling angle. The image capturing means 2a is configured for capturing a series of images successive in time.

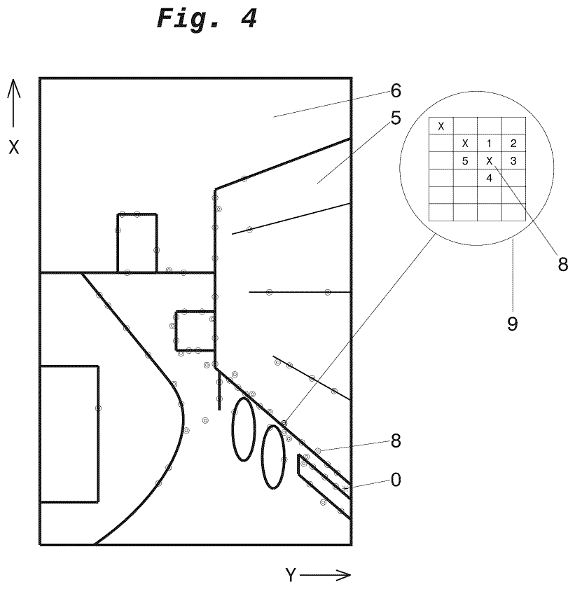

FIG. 3 shows a camera image 6 captured by the camera-based system of FIG. 1, as an image of the trailer 5 displayed on a monitor together with rearward traffic 7. FIG. 4 serves to illustrate the determination of feature points 8 in this camera image 6.

According to a preferred embodiment of the method according to the invention for determining the trailer end or the trailer end edge in the camera image 6 a plurality of feature points 8 are determined in the two-dimensional camera image 6 with the coordinate axis x and y, as shown in FIG. 4. The feature points 8 each correspond to a single pixel or several pixels in a pixel cluster. FIG. 4 illustrates a pixel field 9 in an enlarged view of a partial section of the camera image 6. According to the preferred embodiment, for example, a pixel that has the neighboring pixels 1 to 5 is determined as a feature point if there is a predetermined contrast difference at least to a part of the neighboring pixels. Other image parameters for determining whether a pixel is a feature point, or not, can be alternatively or cumulatively used.

According to the preferred embodiment of the method according to the invention, the feature points 8 determined in FIG. 4 are weighted for emphasizing or better determining a contrast difference between neighboring pixels or pixels in spatial proximity. A weighting parameter can for example be speed at which feature points change relative to the tractor, i.e. regarding their position on the image sensor: none or only minor changes can be weighted higher, as it can be assumed that they are points that move with the vehicle and are therefore on the trailer, for example. For the further processing according to the method of the invention, only feature points having a predetermined weighting or higher, for example, are used, so that not all feature points must be used which saves computing capacity.

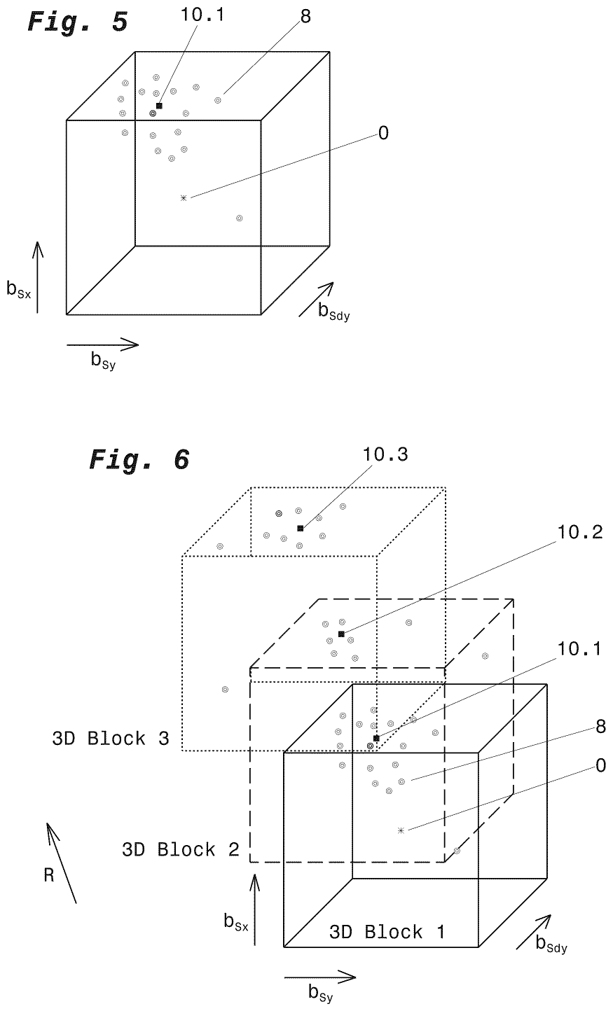

According to the preferred embodiment of the method according to the invention, path elements 10 are selected from the feature points 8 shown in FIG. 4, as described below with respect to FIGS. 5 and 6.

According to the preferred embodiment of the method according to the invention, first a starting point 0 is defined in the camera image 6, as shown in FIG. 4. The starting point 0 can but does not have to be a feature point 8. The starting point 0 can be set, for example, based on the buckling angle and the resulting position of the trailer relative to the image capturing means. As shown in FIG. 5, starting from the starting point 0, an image section is defined which, for better visualization, is shown in FIGS. 5 and 6 as a three-dimensional block having a fixed or dynamically adjustable block size (bs). Within this 3D block there are a corresponding plurality of feature points of FIG. 4, which are distributed in a three-dimensional space around the starting point 0 as the center point of the block of the size (bs). Each of these feature points is characterized by a x-coordinate (bsₓ), a y-coordinate (bs_{y}), a dx-coordinate (not shown in FIG. 5) and a dy-coordinate ((bs_{dy}). The dx-coordinate and the dy-coordinate represent the positional shift (displacement) of a feature point between camera images captured successively in time.

From the “feature point cloud” as shown in FIG. 5, at least one path element 10.1 is determined. According to the preferred embodiment of the method of the invention, this path element corresponds to a center (center of gravity) of the “feature point cloud”. The path element 10.1 can therefore be one of the feature points of the “feature point cloud”, or merely be there, where the most feature points in the block are spatially located. It therefore does not have to be a feature point 8.

As shown in FIG. 6, for selecting a next path element 10.2, a new image section or 3D block is defined starting from the path element 10.1 as new starting point, having the same or another block size as the initial block, for example, depending on the feature points present in this section. Selecting the path element 10.2 is performed in the same way as for path element 10.1. In this way the path elements 10 are determined along a preferred direction R from the feature points. According to the preferred embodiment of the method according to the invention, the preferred direction R is determined by the density and position of the feature points and can either be fixed or adapted dynamically during the method.

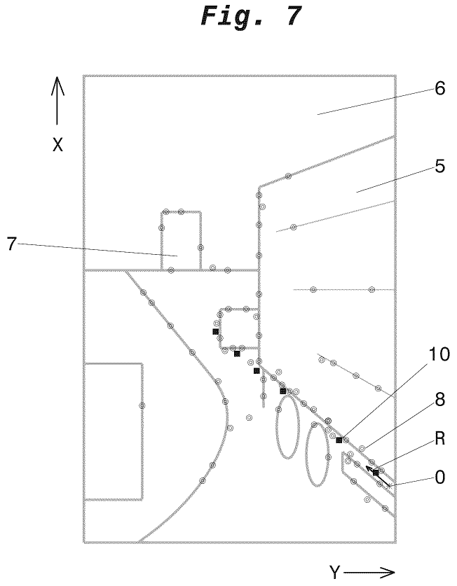

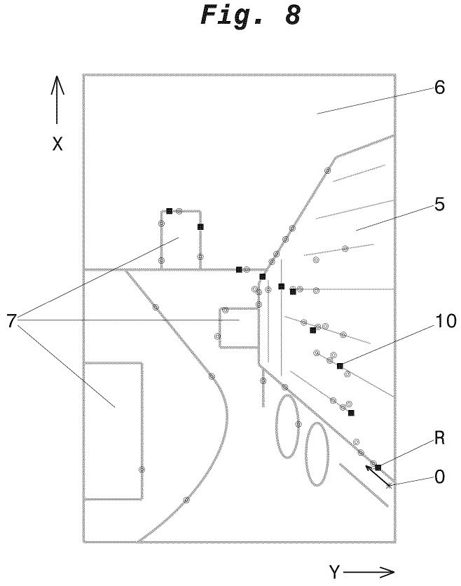

FIG. 7 illustrates the determined path elements 10 according to the preferred embodiment of the method of the invention superimposed on a camera image 6 together with the feature points 8. According to FIG. 7, the path elements 10 extend along the preferred direction R at the lower edge of the trailer 5. Depending on the structure of the trailer 5 and the corresponding different distribution of feature points or/and path elements, the path elements 10 can extend as shown in FIG. 8, for example, i.e. not along the lower edge of the trailer 5. In both cases, a position of the trailer end or the trailer end edge can be determined according to the preferred embodiment of the method according to the invention, as will be explained further below.

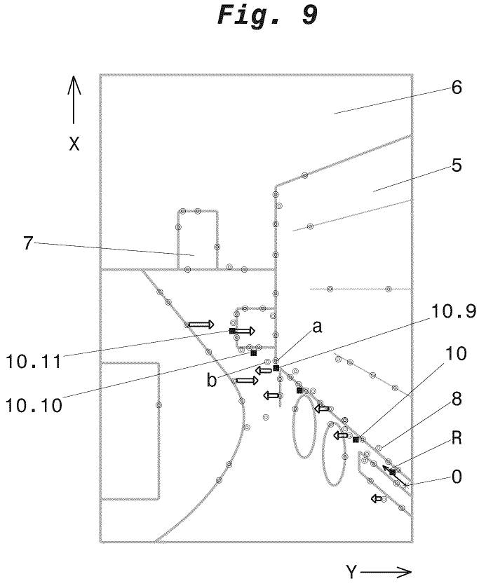

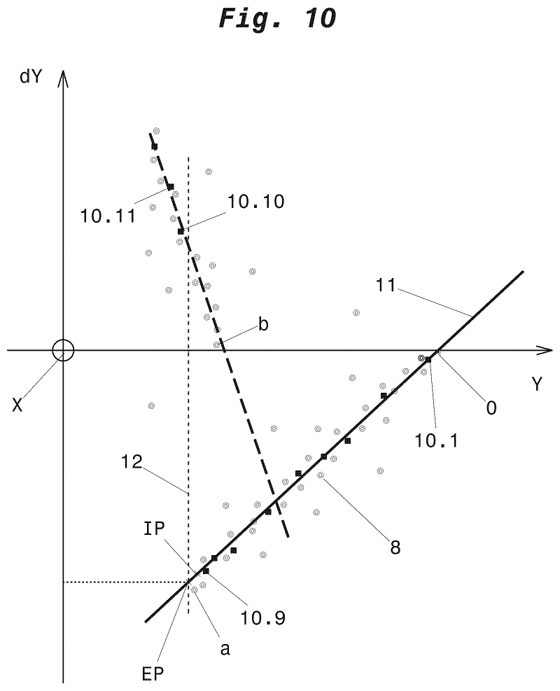

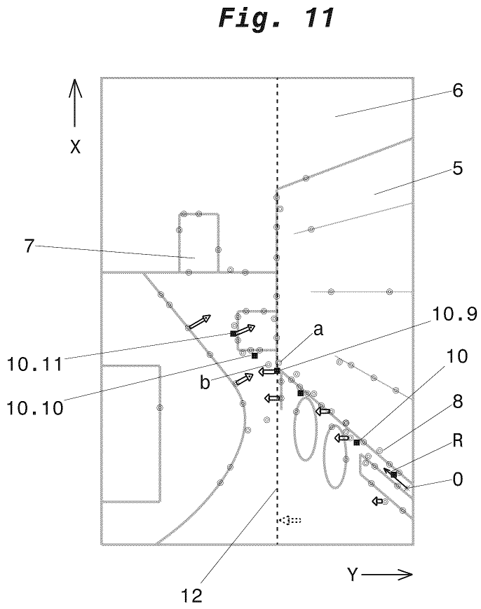

FIG. 9 shows a symbolic representation of the movement of the determined path elements 10.1 to 10.11 or feature points 8 in the camera image 6 to better illustrate the determination of the path or trailer end. For a better understanding, the path elements 10.1 to 10.11 and the feature points 8 of FIG. 9 are projected onto a coordinate system of FIG. 10. FIG. 10 shows the coordinate axes y, x (out of the plane) and dy.

According to the preferred embodiment of the method according to the invention, a path 11 is generated based on the path elements, which is a straight line in this preferred embodiment. The path 11 can also be generated as a polynomial of nth order, wherein several different paths with different orders of polynomial can also be generated. Before the path 11 is generated, the path elements 10 can be at least partly weighted based on a position or sequence (order). A metric with weights of the path elements can be used, wherein the coordinates of the path elements and/or characteristics (properties) of the set of feature points that they represent can be used, for example how many feature points, scattering of their coordinate values, scattering of “score-values”, i.e. properties that turn feature points into feature points.

As shown in FIG. 10, all path elements 10.1 to 10.9 lie within a predetermined distance from the path 11. The determined path elements 10.10 and 10.11, which do not belong to the trailer 5, but to a curbside, as shown in FIG. 9, are lie outside the predetermined distance and therefore not on the path 11. As shown in FIG. 9 and in FIG. 10, the path elements 10.10 and 10.11 move faster than the path elements 10.1 to 10.9 when cornering and can therefore be identified as not belonging to the path 11.

According to the preferred embodiment of the method according to the invention, for determining the position of the trailer end, the last path element 10.9 which has been considered for the determination of the path 11 and which thus has been identified with a sufficient certainty as belonging to the trailer, is used as an initial point starting from which further feature points 8 are analyzed with respect to their spatial proximity to the path 11. For example, it is possible that in the previous steps a feature point was not identified as belonging to the path 11 because thresholds were set too coarsely, or the image sections or blocks of FIG. 6 for determining the path elements have been in different directions. In this way, the method according to the invention is further refined, wherein the coordinate of the last found feature point, which lies within the predetermined distance from the path 11, describes the trailer end. Alternatively, the end of the trailer can also be calculated from several last found feature points. In FIGS. 9 and 10, this is indicated by EP or a. In other words, the trailer end is determined as the location on the path at which, viewed in the direction away from the tractor and furthest away from the tractor unit, the image parameter determined for selecting the feature points changes permanently in this direction for the first time (i.e. not just after a short suspension along the path, for example). The initial point IP can lie on the path and/or be at least one path element, and/or be at least one feature point having a given distance from the path. Calculation variables (calculated quantities) of several path elements and/or feature points can be used, for example mean values, centers of gravity, least square deviations, etc.

FIG. 11 illustrates a projection of a vertical line 12 at the coordinate a of the last found feature point in the camera image 6 to indicate the trailer end determined by the method according to the invention.

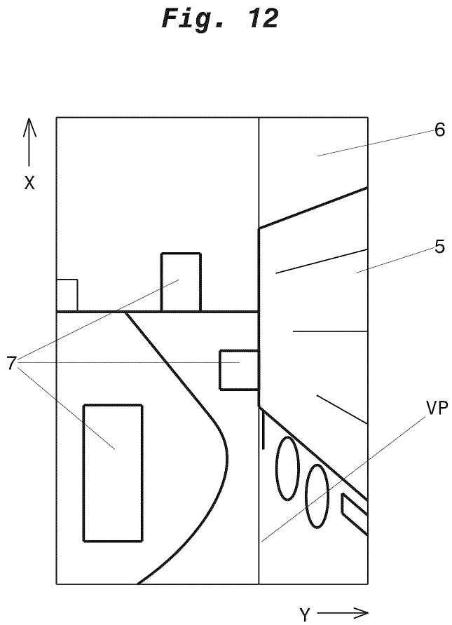

According to the preferred embodiment of the method of the invention, the position of the trailer end determined in the above manner is further used to track (update) the trailer end during cornering of the vehicle in a monitor image displayed to the driver of the vehicle such that it appears at a preferred position in the monitor image, for example at the center or plus minus 0% to 25% shifted from the center to the left or right, as shown in FIG. 12, in order, among other things, to reliably keep an eye on the traffic behind.

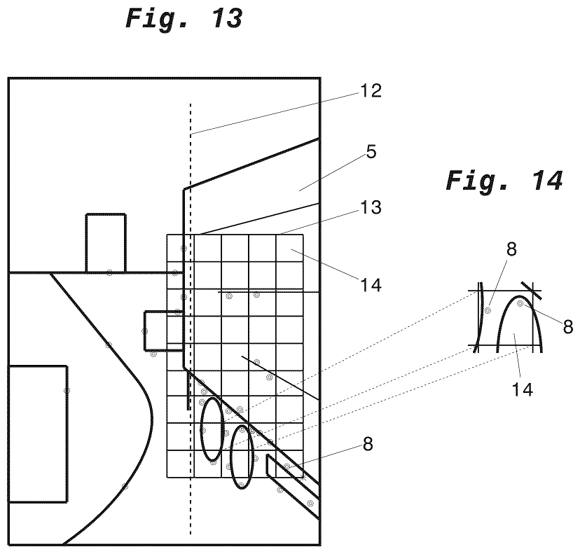

According to the preferred embodiment of the method of the invention, there is further a verification of the trailer end determined in the above manner. For this purpose, a block grid 13 is generated on a section of the camera image 6, as shown in FIG. 13. The block grid 13 has, according to the preferred embodiment of the method of the invention, a fixed shape and a fixed number of rows and columns forming a plurality of cells 14. In the block grid 13 in FIG. 13, the number of columns is different from the number of rows. In principle, a grid layout other than rectangular cells could also be used.

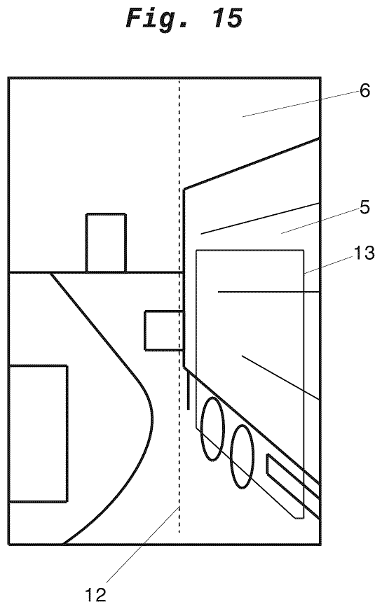

According to the preferred embodiment of the method of the invention, a distribution of the plurality of feature points 8 determined in the above-mentioned manner is determined over the plurality of cells 14. The cell 14 shown in FIG. 14, for example, comprises two feature points 8. The distribution of feature points over the cells of the generated block grid 13 is then compared with distributions of feature points of a plurality of corresponding stored block grids (not shown). The stored block grids each define different distributions of feature points together with a position of the actual trailer end and a buckling angle. According to the preferred embodiment of the method of the invention, a corresponding stored block grid in which the actual trailer end is defined is selected based on the buckling angle and/or position of the trailer end or information about the relative positional relationship between towing unit and trailer, and a correlation of the distribution of feature points in the generated block grid and in the stored block grid. By comparing this actual trailer end with the (input) previously determined trailer end, this can be verified and, if necessary, rejected or corrected.

According to the preferred embodiment of the method of the invention, the distribution of the feature points and the corresponding trailer ends in the stored block grids can be stored in advance or generated and stored in real time during performing the method at fixed defined or dynamically selected time intervals.

By using stored block grids in which in addition to the distribution of the feature points over the cells information about the trailer end is stored, the trailer end can be determined without presence of a trailer end to be verified by comparing a generated block grid with the stored block grids and can be used for center tracking in a camera image, as mentioned above.

FIG. 15 shows a tracked (updated) position of the trailer end in a camera image 6 at a preferred position in a displayed monitor image. The preferred position is for example the center of the monitor image or shifted to the left or right by 0% to 25% from the center, for example. The preferred position can also be offset by 0% to 25% from the left or right edge of the monitor image.

It is explicitly emphasized that all features disclosed in the description and/or the claims are understood to be separate or independent of each other for the purpose of the original disclosure as well as for the purpose of limiting the claimed invention independently of the combinations of features in the embodiments and/or claims. It is explicitly stated that any range specifications or specifications of groups of units include any intermediate value or subgroup of units for the purpose of the original disclosure as well for limiting the claimed invention, in particular also the limit of a range indication.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for determining the position of a trailer end in a camera image of a trailer extending rearward from a towing unit of a vehicle and being pivotable to the towing unit, by processing camera images captured successively in time, comprising the steps of:
capturing the camera images being successive in time by at least one image sensor of at least one image capturing means;
determining a plurality of feature points in each camera image used for the method, based on at least one image parameter, wherein a feature point corresponds to at least one pixel in the camera image;
determining at least one path element by using the plurality of feature points along a predetermined direction in relevant coordinates x and/or y and/or dx and/or dy based on a determined positional shift in corresponding coordinates x and/or y and/or dx and/or dy between the plurality of feature points in at least one camera image and a corresponding plurality of feature points in at least one camera image successive in time;
generating of at least one path along the predetermined direction based on the path elements, the path describing the position of the trailer; and
determining a position on the path as the trailer end.

2. The method according to claim 1, wherein the predetermined direction is determined by density and position of the feature points.

3. The method according to claim 1, further comprising the steps:
weighting the feature points; and
determining the path elements from the weighted feature points.

4. The method according to claim 1, further comprising the steps:
weighting the path elements; and
generating the at least one path based on the weighted path elements.

5. The method according to claim 1, further comprising the step of
acquiring information about the relative positional relationship between the trailer and the towing unit of the vehicle, wherein the determining of the path elements, the weighting of the feature points and/or the weighting of the path elements is based on the acquired information about the relative positional relationship between the trailer and the towing unit of the vehicle.

6. The method according to claim 1, wherein the at least one path is generated as a mathematical function specified by the path elements or weighted path elements.

7. The method according to claim 1, wherein the at least one image parameter is at least one of brightness value, color value, grey tone, contrast value and/or a calculated quantity from one of these values and/or their gradients of a pixel and/or pixel cluster in a camera image.

8. The method according to claim 1, further comprising
setting, as a starting point, an initialization point (IP), that is located on the generated path, or that is at least one path element of the at least one path, or that is at least a further feature point that does not exceed a predetermined distance from the at least one path, or a calculated quantity of the path elements or the further feature points; and
searching for at least a further feature point starting from the starting point and along the path, that does not exceed a predetermined distance from the at least one path; and
setting a coordinate of the at least one further identified feature point and/or a calculated quantity of the at least one feature points as the position (EP) of the trailer end.

9. The method according to claim 1, further comprising the steps of
acquiring at least one vehicle feature; and
correcting the determined position of the trailer end based on the acquired at least one vehicle feature.

10. The method according to claim 1, further comprising the step of verifying the determined position of the trailer end, wherein the step of verifying comprises following steps:
generating a block grid on at least a section of the camera image, wherein the block grid defines a plurality of cells, and determining a distribution of the plurality of feature points over the plurality of cells of the block grid as part of the generated block grid;
comparing the distribution of feature points in the generated block grid with distributions of feature points of a plurality of stored corresponding block grids, wherein the stored block grids each define different distributions of feature points together with an actual trailer end;
selecting one of the stored block grids based on a correlation between the distribution of feature points in the generated block grid and the distribution of feature points in the stored block grids;
verifying the determined position of the trailer end by comparing the actual position of the trailer end defined by the selected block grid with the determined position of the trailer end, and/or further comprising a correcting of the determined position of the trailer end based on the verification, and/or wherein the distributions of feature points and the corresponding trailer ends in the stored block grids are stored in advance or generated and stored in real time in fixed defined or dynamically adjustable time intervals.

11. The method according to claim 10, wherein the distribution of feature points in one of the stored block grids differs from the distributions of feature points in another of the stored block grids according to information about the relative positional relationship between trailer and towing unit.

12. The method according to claim 1, comprising
tracking the determined position of the trailer end in camera images which are successive in time, depending on the position of the trailer with respect to the image sensor acquiring the camera images such that the trailer end appears at a preferred position in the monitor image of at least one display means of a camera-based system.

13. A camera-based system of a vehicle having a towing unit and a trailer rearwardly extending and being pivotable to the towing unit, comprising:
at least one image capturing means provided at the towing unit and having at least one image sensor for capturing camera images of an area of the trailer which are successive in time; and
at least one processing means configured for performing the method according to claim 1.

14. The camera-based system according to claim 13, further comprising at least one display means for displaying a camera image captured by the at least on image capturing means and tracking the determined position of the trailer end in the camera images which are successive in time depending on the position of the trailer with respect to the image sensor acquiring the camera image such that the trailer end appears at a preferred position in the monitor image of the display means.

15. The camera-based system according to claim 13, which is approved according to UN ECE R46.
